(19) United States
(12) Patent Application Publication
(10) Pub. No.: US 2026/0344571 A1
(43) Pub. Date: Nov. 5, 2026

(54) OUTDOOR GARDEN WORKING VEHICLE AND RIDE-ON LAWN MOWER

(71) Applicant: JIANGSU DONGCHENG M&E TOOLS CO., LTD., Nantong (CN)

(72) Inventors: Wanzhao YU, Nantong (CN); Shengwen ZHANG, Nantong (CN); Huixing FU, Nantong (CN)

(21) Appl. No.: 19/723,046

(22) Filed: Jun. 29, 2026

Related U.S. Application Data
(63) Continuation of application No. PCT/CN2024/143011, filed on Dec. 27, 2024.

(30) Foreign Application Priority Data
Dec. 29, 2023 (CN) 202311853828.7
Dec. 29, 2023 (CN) 202311853829.1
Dec. 29, 2023 (CN) 202311853833.8
Dec. 29, 2023 (CN) 202311856724.1

(51) Int. Cl. A01D 69/10; A01D 101/00

(52) U.S. Cl. CPC A01D 69/10; A01D 2101/00

(57) ABSTRACT

An outdoor garden working vehicle is provided, including: a frame; a left drive axle assembly mechanically coupled between a left drive motor and a left drive wheel; a right drive axle assembly mechanically coupled between a right drive motor and a right drive wheel; a working mechanism disposed at a lower portion of the frame for ground work; a power supply unit electrically connected to the left and right drive motors and the working mechanism and configured to supply power to the left and right drive motors and the working mechanism; and a braking module. The braking module includes a parking and service brake assembly and a foot brake pump. The parking and service brake assembly includes a pedal assembly configured to press, when being depressed by a user, the foot brake pump to generate a braking force on the left and right drive axle assemblies.

### CROSS-REFERENCE TO RELATED APPLICATIONS

This application is a continuation of an International application No. PCT/CN2024/143011 filed on Dec. 27, 2024, which claims the priorities to Chinese Patent Application No. 202311853829.1, filed with the China National Intellectual Property Administration on Dec. 29, 2023, Chinese Patent Application No. 202311853828.7, filed with the China National Intellectual Property Administration on Dec. 29, 2023, Chinese Patent Application No. 202311853833.8, filed with the China National Intellectual Property Administration on Dec. 29, 2023, and Chinese Patent Application No. 202311856724.1, filed with the China National Intellectual Property Administration on Dec. 29, 2023, the disclosure of which are incorporated herein by reference in their entireties.

### FIELD

The present disclosure relates to the technical field of garden working vehicles, and in particular to an outdoor garden working vehicle.

### BACKGROUND

An outdoor garden working vehicle generally refers to a vehicle that performs garden working outdoors, and mainly includes a vehicle for cutting and maintaining turf on a lawn.

The entire vehicle of the garden working vehicle needs to travel on the ground during operation, and thus is equipped with a brake component for braking. For example, Chinese Patent Publication No. CN207269396U discloses a brake and parking mechanism of an electric zero-turn lawn mower, and the brake and parking mechanism includes an operating mechanism and a braking mechanism. The operating mechanism is arranged at a front end of a vehicle frame, and includes a brake pedal and a parking pedal. The brake mechanism includes a hub motor connected to a wheel, and a brake caliper arranged on the vehicle frame. The brake caliper cooperates with a brake disc of the hub motor. With reference to the drawings of CN207269396U, it can be clearly seen that the brake disc is provided on a wheel axle. Although this patent can achieve a certain wheel braking effect, the brake caliper needs to provide a very large clamping torque to generate an effective braking force due to the brake disc being provided on the wheel axle, hindering a user from achieving a good braking effect by directly depressing the pedal.

To enable the vehicle to be effectively maintained at a predetermined position, a parking system is generally provided on the vehicle to maintain the vehicle's relative position during parking. For example, U.S. Pat. No. 11,589,513B2 discloses an integrated parking brake system for a ride-on lawn care vehicle, including a parking brake device that is activated based on a result detected by an operator presence detection system as to whether there is an operator in the vicinity of an electric off-road working vehicle. The operator presence detection system can send a signal to a controller, upon which the controller may command the parking brake device to switch between an engaged state and a non-engaged state. In U.S. Pat. No. 11,589,513B2, a braking operation and a parking operation are significantly different, whereas according to user operating habits, a larger braking force may cause the vehicle to be equivalent to a parking state or directly enter the parking state. Therefore, the operating mechanism of this patent is difficult for users to adapt.

Braking generally involves pressing or depressing a predetermined component to apply a braking force to a brake system. However, due to structural limitations of a brake disc in the brake system, a friction pad that abuts against the brake disc cannot continue to move once fully abutting with the brake disc, which avoids the user from continuing pressing or depressing the component and thus results in an “overly hard” brake feel, degrading the user's experience. For example, Chinese Patent Publication No. CN114684080B discloses a braking system for an electric lawn mower, which integrates service braking, emergency braking, and parking braking functions through a brake operating assembly. However, CN114684080B provides a lower limit bolt to limit a position of a pedal, which obviously avoids the pedal from being further depressed upon braking, resulting in an “overly hard” brake feel. Moreover, in this patent, a second depression of the brake pedal in a parking state releases the parking state, which increases the possibility of misoperation.

### SUMMARY

Embodiments of the present disclosure provide an outdoor garden working vehicle including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a mowing mechanism disposed at a lower portion of the frame for cutting ground vegetation; a power supply unit electrically connected to the left drive motor, the right drive motor, and the mowing mechanism, and configured to supply power to the left drive motor, the right drive motor, and the mowing mechanism; and a braking module including a parking and service brake assembly and a foot brake pump. The parking and service brake assembly includes a pedal assembly hinged to the frame. A lever is formed by the pedal assembly and the foot brake pump. The foot brake pump is actuated through depression of the pedal assembly by a user to generate a braking force on the left drive axle assembly and the right drive axle assembly.

Embodiments of the present disclosure further provide a lawn mower including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a mowing mechanism disposed at a lower portion of the frame for cutting ground vegetation; a power supply unit electrically connected to the left drive motor, the right drive motor, and the mowing mechanism, and configured to supply power to the left drive motor, the right drive motor, and the mowing mechanism; and a braking module including a parking and service brake assembly and a foot brake pump. The parking and service brake assembly includes a pedal assembly hinged to the frame. A lever is formed by the pedal assembly and the foot brake pump. The foot brake pump is actuated through depression of the pedal assembly by a user to generate a braking force on the left drive axle assembly and the right drive axle assembly.

Embodiments of the present disclosure further provide an electric outdoor garden working vehicle including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a working mechanism disposed at a lower portion of the frame for performing outdoor work on the ground; a power supply unit electrically connected to the left drive motor, the right drive motor, and the working mechanism, and configured to supply power to the left drive motor, the right drive motor, and the working mechanism; and a braking module including a parking and service brake assembly and a foot brake pump. The parking and service brake assembly includes a pedal assembly hinged to the frame. A lever is formed by the pedal assembly and the foot brake pump. The foot brake pump is actuated through depression of the pedal assembly by a user to generate a braking force on the left drive axle assembly and the right drive axle assembly.

Embodiments of the present disclosure further provide an outdoor garden working vehicle including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a mowing mechanism disposed at a lower portion of the frame for cutting ground vegetation; a power supply unit electrically connected to the left drive motor, the right drive motor, and the mowing mechanism, and configured to supply power to the left drive motor, the right drive motor, and the mowing mechanism; and a braking module including a parking and service brake assembly. The parking and service brake assembly is configured to be depressed by a user to generate a braking force on the left drive axle assembly and the right drive axle assembly. The parking and service brake assembly includes a pedal assembly including a main pedal and an auxiliary pedal. The main pedal is configured to be depressed by the user to bring the braking module into either a braking state or a parking state, and the auxiliary pedal is configured to be depressed by the user to release the braking module from the parking state.

Embodiments of the present disclosure further provide a ride-on lawn mower including: a frame; a seat connected to the frame for a user to sit on; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a mowing mechanism disposed at a lower portion of the frame for cutting ground vegetation; a power supply unit electrically connected to the left drive motor, the right drive motor, and the mowing mechanism, and configured to supply power to the left drive motor, the right drive motor, and the mowing mechanism; and a braking module including a parking and service brake assembly. The parking and service brake assembly is configured to be depressed by a user to generate a braking force on the left drive axle assembly and the right drive axle assembly. The parking and service brake assembly includes a pedal assembly including a main pedal and an auxiliary pedal. The main pedal is configured to be depressed by the user to bring the braking module into either a braking state or a parking state, and the auxiliary pedal is configured to be depressed by the user to release the braking module from the parking state.

Embodiments of the present disclosure further provide a lawn mower including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a working mechanism disposed at a lower portion of the frame for performing outdoor work on the ground; a power supply unit electrically connected to the left drive motor, the right drive motor, and the working mechanism, and configured to supply power to the left drive motor, the right drive motor, and the working mechanism; and a braking module including a parking and service brake assembly. The parking and service brake assembly is configured to be depressed by a user to generate a braking force on the left drive axle assembly and the right drive axle assembly. The parking and service brake assembly includes a pedal assembly including a main pedal and an auxiliary pedal. The main pedal is configured to be depressed by the user to bring the braking module into either a braking state or a parking state, and the auxiliary pedal is configured to be depressed by the user to release the braking module from the parking state.

Embodiments of the present disclosure further provide an electric outdoor garden working vehicle including: a frame; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a working mechanism disposed at a lower portion of the frame for performing outdoor work on the ground; a power supply unit electrically connected to the left drive motor, the right drive motor, and the working mechanism, and configured to supply power to the left drive motor, the right drive motor, and the working mechanism; and a braking module including a parking and service brake assembly and a foot brake pump. The parking and service brake assembly includes a pedal assembly. The pedal assembly is configured to press, when being depressed by the user, the foot brake pump to generate a braking force on the left drive axle assembly and the right drive axle assembly.

Embodiments of the present disclosure further provide a ride-on outdoor garden working vehicle including: a frame; a seat connected to the frame for a user to sit on; a left drive axle assembly and a right drive axle assembly, in which the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel; a working mechanism disposed at a lower portion of the frame for performing outdoor work on the ground; a power supply unit electrically connected to the left drive motor, the right drive motor, and the working mechanism, and configured to supply power to the left drive motor, the right drive motor, and the working mechanism; and a braking module including a parking and service brake assembly. The parking and service brake assembly is configured to be depressed by a user to generate a braking force on the left drive axle assembly and the right drive axle assembly. The parking and service brake assembly includes a pedal assembly including a main pedal and an auxiliary pedal. The main pedal is configured to be depressed by the user to bring the braking module into either a braking state or a parking state, and the auxiliary pedal is configured to be depressed by the user to release the braking module from the parking state.

Embodiments of the present disclosure further provide a zero-turn lawn mower including: a frame; a drive axle assembly including a left drive axle assembly and a right drive axle assembly, in which each of the left drive axle assembly and the right drive axle assembly is mechanically coupled between a drive motor and a drive wheel on a corresponding side to transmit power from the drive motor to the drive wheel; a mowing mechanism disposed at a lower portion of the frame for cutting ground vegetation; a power supply unit electrically connected to the drive motor of each of the left drive axle assembly and the right drive axle assembly and the mowing mechanism, and configured to supply power to the drive motors and the mowing mechanism. Each of the left drive axle assembly and the right drive axle assembly includes a housing and a plurality of shafts. At least one of the shafts is connected to a neutral mechanism. The neutral mechanism is configured to be controlled to bring the drive axle assembly into a neutral state or an engaged state. The drive axle assembly is configured to transmit power from the drive motor to the drive wheel in the engaged state, and stop transmitting power from the drive motor to the drive wheel in the neutral state. The plurality of shafts include an input shaft mechanically coupled to the drive motor and configured to be driven by the drive motor to rotate, and an output shaft coupled between the input shaft and the drive wheel and configured to output power from the drive motor to the drive wheel.

Embodiments of the present disclosure further provide an outdoor garden working vehicle including: a frame; a drive axle assembly including a left drive axle assembly and a right drive axle assembly, in which each of the left drive axle assembly and the right drive axle assembly is mechanically coupled between a drive motor and a drive wheel on a corresponding side to transmit power from the drive motor to the drive wheel; a working mechanism disposed at a lower portion of the frame for performing outdoor work on the ground; a power supply unit electrically connected to the drive motor of each of the left drive axle assembly and the right drive axle assembly and the working mechanism and configured to supply power to the drive motors and the working mechanism. Each of the left drive axle assembly and the right drive axle assembly includes a housing and a plurality of shafts. At least one of the shafts is connected to a neutral mechanism. The neutral mechanism is configured to be controlled to bring the drive axle assembly into a neutral state or an engaged state. The drive axle assembly is configured to transmit power from the drive motor to the drive wheel in the engaged state, and stop transmitting power from the drive motor to the drive wheel in the neutral state. The plurality of shafts include an input shaft mechanically coupled to the drive motor and configured to be driven by the drive motor to rotate, and an output shaft coupled between the input shaft and the drive wheel and configured to output power from the drive motor to the drive wheel.

Embodiments of the present disclosure further provide a ride-on outdoor garden working vehicle including: a frame; a seat connected to the frame for a user to sit on; a drive axle assembly including a left drive axle assembly and a right drive axle assembly, in which each of the left drive axle assembly and the right drive axle assembly is mechanically coupled between a drive motor and a drive wheel on a corresponding side to transmit power from the drive motor to the drive wheel; a working mechanism disposed at a lower portion of the frame for performing outdoor work on the ground; a power supply unit electrically connected to the drive motor of each of the left drive axle assembly and the right drive axle assembly and the working mechanism and configured to supply power to the drive motors and the working mechanism. Each of the left drive axle assembly and the right drive axle assembly includes a housing and a plurality of shafts. At least one of the shafts is connected to a neutral mechanism. The neutral mechanism is configured to be controlled to bring the drive axle assembly into a neutral state or an engaged state. The drive axle assembly is configured to transmit power from the drive motor to the drive wheel in the engaged state, and stop transmitting power from the drive motor to the drive wheel in the neutral state. The plurality of shafts include an input shaft mechanically coupled to the drive motor and configured to be driven by the drive motor to rotate, and an output shaft coupled between the input shaft and the drive wheel and configured to output power from the drive motor to the drive wheel.

### BRIEF DESCRIPTION OF DRAWINGS

Specific embodiments of the present disclosure are described in detail below in conjunction with the accompanying drawings.

FIG. 1 is a perspective view of an outdoor garden working vehicle according to some embodiments of the present disclosure.

FIG. 2 is an exploded view of a braking module and drive axle of FIG. 1.

FIG. 3 is a perspective view of a pedal assembly and a foot brake pump of FIG. 2.

FIG. 4 is an exploded view of the pedal assembly and the foot brake pump of FIG. 2.

FIG. 5 is an exploded view of the pedal assembly of FIG. 2.

FIG. 6 is a perspective view of a brake caliper according to some embodiments of the present disclosure.

FIG. 7 is a perspective view of the brake caliper with a friction pad separated therefrom according to some embodiments of the present disclosure.

FIG. 8 is a schematic diagram of a recognition module and a control system according to some embodiments of the present disclosure.

FIG. 9 is a perspective view of a zero-turn lawn mower according to some embodiments of the present disclosure.

FIG. 10 is an exploded view of a drive axle assembly portion of FIG. 9.

FIG. 11 is a perspective view of a limiting plate portion shown in FIG. 10 from one viewing angle.

FIG. 12 is a perspective view of the limiting plate portion shown in FIG. 10 from another viewing angle.

FIG. 13 is an exploded view of the limiting plate portion shown in FIG. 10.

FIG. 14 is a schematic diagram of a recognition module and a control system according to some embodiments of the present disclosure.

FIG. 15 is a schematic diagram of an operating portion using a hand brake and a hand brake cable according to some embodiments of the present disclosure.

FIG. 16 is a schematic diagram of an operating portion using a control switch and an electric linear actuator according to some embodiments of the present disclosure.

FIG. 17 is a schematic diagram of an action portion using an electromagnetic clutch according to some embodiments of the present disclosure.

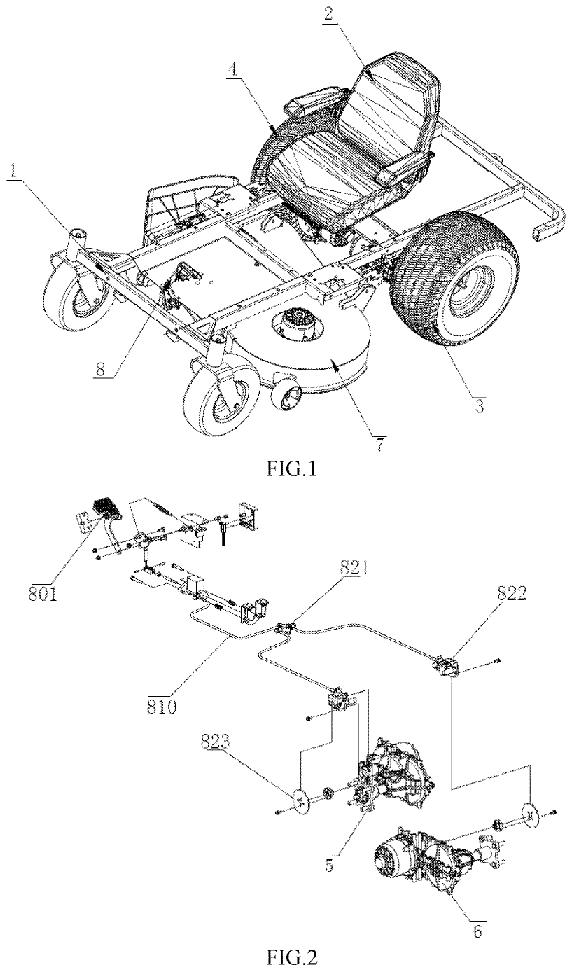

Reference numerals in FIGS. 1-8:

1: frame; 2: user seat; 3: left drive wheel; 4: right drive wheel; 5: left drive axle assembly; 6: right drive axle assembly; 7: mowing mechanism; 8: braking module; 801: main pedal; 802: auxiliary pedal; 803: auxiliary pedal torsion spring; 804: hook plate; 805: hook plate torsion spring; 806: limit rod; 807: rotation plate; 808: brake spring; 809: fixing bracket; 810: hydraulic tube; 811: foot brake pump; 812: threaded push rod; 813: oil pump bracket; 814: bolt; 815: damping compression spring; 816: first connection plate; 817: adjustment nut; 818: micro switch; 819: switch pressing plate; 820: switch box; 821: three-way valve block; 822: brake caliper; 8221: caliper hydraulic cylinder; 8222: friction pad; 8223: caliper piston rod; 823: brake disc; 824: floating mounting bracket.

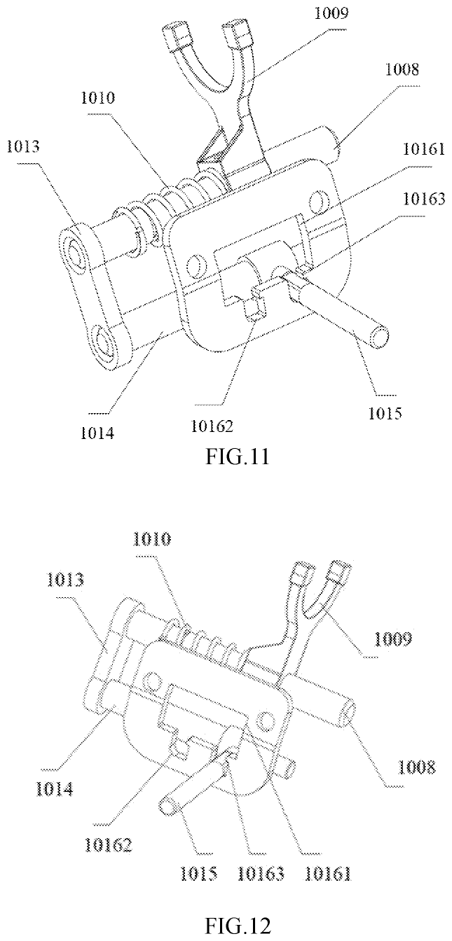

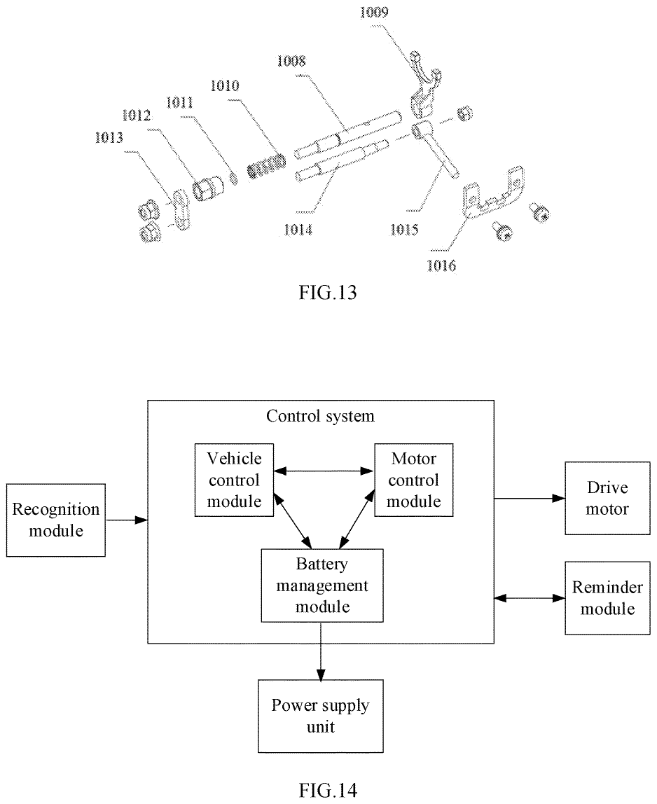

Reference numerals in FIGS. 9-17:

1001: drive motor; 1002: sliding gear; 1003: input shaft; 1004: intermediate shaft; 1005: output shaft; 1006: upper housing of a gear reducer; 1007: lower housing of the gear reducer; 1008: sliding rod; 1009: neutral shifting fork; 1010: spring; 1011: O-ring; 1012: screw plug; 1013: second connection plate; 1014: pull rod; 1015: handle; 1016: limiting plate; 10161: slide channel; 10162: limiting groove; 10163: limiting protrusion; 1017: hand brake; 1018: control switch; 1019: electric linear actuator; 1020: electromagnetic clutch; 1021: synchronizer.

### DETAILED DESCRIPTION OF PREFERRED EMBODIMENTS

The terminology used in the present disclosure is merely for describing particular embodiments and is not intended to limit the present disclosure. For example, words such as “upper,” “lower,” “front,” and “rear” that indicate orientation or positional relationships are based solely on the orientations or positional relationships shown in the drawings, and are merely for the convenience of describing the present disclosure and simplifying the description. They are not intended to indicate or imply that the associated device or element must have a particular orientation, or be constructed or operated in a particular orientation, and thus should not be construed as limiting the present disclosure.

Unless otherwise specified, the terms “disposed,” “connected,” and “coupled” as used in the present disclosure should be interpreted in a broad sense. For example, the connection may be a fixed connection, a detachable connection, or an integral connection; or may be a direct connection or an indirect connection through an intermediate medium. The term “fixedly connected” as used in the present disclosure should also be interpreted broadly as integrally formed, welded, or connected by other fasteners.

In the related art, since an entire vehicle of a garden working vehicle runs on the ground during operation, the garden working vehicle is equipped with a brake component for braking. In some existing brake components, a brake disc is mounted on a wheel axle, and a brake caliper cooperates with the brake disc to perform braking. This arrangement requires a brake caliper to apply a high clamping torque to achieve effective braking, making it difficult for users to obtain satisfactory braking performance simply by stepping on a pedal.

In addition, the garden working vehicle is generally equipped with a parking system to keep the vehicle stationary during parking. In some designs, the braking function and the parking function are implemented via distinctly separate operating modes. However, such operation does not conform to regular user habits, since a large braking force usually tends to bring the vehicle into a parking state. Accordingly, such structures are inconvenient for users to operate.

Braking generally involves pressing or depressing a predetermined component to apply a braking force to a brake system. However, due to the structural limitations of a brake disc in the brake system, a friction pad that abuts against the brake disc cannot continue to move once fully abutting with the brake disc, which avoids a user from continuing pressing or depressing the component and thus results in an “overly hard” brake feel, degrading the user's experience.

In view of the above, according to some embodiments of the present disclosure, an outdoor garden working vehicle is provided. In the outdoor garden working vehicle, by configuring a connection between a pedal assembly and a foot brake pump as a mechanical advantage lever and disposing a brake disc on a non-output shaft of a gear reducer, a reduction ratio of the gear reducer allows the user to generate sufficient braking force without applying an excessively large force to depress the pedal assembly, thereby eliminating the need for a very large force to achieve effective braking.

Furthermore, depressing a main pedal achieves braking, and further depressing the main pedal with greater force achieves parking, so that switching between braking and parking modes is more consistent with user operating habits. When a parking mode needs to be released, the user only needs to depress an auxiliary pedal, which is integrated on one side of the main pedal, allowing the user to complete braking, parking, and parking release operations with a single foot, making the overall operation convenient.

In addition, the foot brake pump is floatingly mounted to the frame via a hydraulic brake force damping adjustment mechanism. When the pedal assembly is depressed by the user to make a friction pad of the brake component fully abut against a brake disc, the pedal assembly may still be further depressed to move for a predetermined distance, so that the user does not experience an “overly hard” brake feel during the entire depression process of the pedal assembly. Moreover, a damping member in the hydraulic brake force damping adjustment mechanism has an initial damping force after being assembled, such that a pedal rebound force experienced by the user during the entire depression process of the pedal assembly gradually increases without any interval where rebound force increases significantly, thereby improving the user's overall braking experience.

FIGS. 1 to 8 show an outdoor garden working vehicle according to some embodiments of the present disclosure. The outdoor garden working vehicle includes: a frame 1, a left drive axle assembly 5, a right drive axle assembly 6, a mowing mechanism 7, a power supply unit, and a braking module.

The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The mowing mechanism 7 is disposed at a lower portion of the frame 1 for cutting vegetation on the ground. In an exemplary embodiment of the present disclosure, the left drive wheel 3 and right drive wheel 4 are disposed at a rear portion of the mowing mechanism 7. It should be particularly noted that the mowing mechanism 7 should not be narrowly interpreted as a mechanism capable only of mowing grass; it may also be replaced with other functional attachments, such as snowplow or snow blower attachments. A person skilled in the art may adaptively replace the mowing mechanism 7 with various functional attachments without creative effort, and all such replacements should fall within the scope of the present disclosure.

The power supply unit is electrically connected to the left drive motor, the right drive motor, and the mowing mechanism 7, and is configured to supply power to the left drive motor, the right drive motor, and the mowing mechanism 7. In some embodiments, the power supply unit is a battery pack. In other embodiments, a combination of an internal combustion engine and a battery may be used. In such a configuration, the internal combustion engine burns fuel to generate electricity via a generator to charge the battery, and power is then supplied to various components of the lawn mower by the battery.

Referring to FIG. 2, the braking module includes a parking and service brake assembly and a foot brake pump 811. The parking and service brake assembly includes a pedal assembly. The pedal assembly is hinged to the frame 1, and a lever is formed by the pedal assembly and the foot brake pump 811. The foot brake pump 811 is actuated through depression of the pedal assembly by the user to generate a braking force on the left drive axle assembly 5 and the right drive axle assembly 6. In the embodiments, a mechanical advantage lever is formed by the pedal assembly and the foot brake pump 811. When the pedal assembly is depressed by the user, a ratio of an input moment arm (also referred to as lever arm or force arm) to an output moment arm of the mechanical advantage lever ranges from 1 to 20:1, allowing the pedal assembly to be depressed by the user with relatively reduced effort.

Referring to FIG. 2, the braking module further includes a hydraulic tube 810, a left brake component, and a right brake component. The hydraulic tube 810 is connected to the foot brake pump 811, the left brake component, and the right brake component. To effectively connect the above components, a three-way valve block 821 is generally provided. Upon depression of the pedal assembly by the user, the foot brake pump 811 is actuated to generate a braking pressure, and the braking pressure is simultaneously applied to the left brake component and the right brake component via the hydraulic tube 810 to generate the braking force on the respective drive axle assembly of the left drive axle assembly 5 and the right drive axle assembly 6, enabling the left drive wheel 3 and the right drive wheel 4 to be braked. A depressing force applied by the user to the pedal assembly for braking ranges from 20 Newton (N) to 500 N.

In some embodiments, the depressing force applied by the user to the pedal assembly for braking ranges from 30 N to 200 N. That is, different braking performance is achievable with a depression force within the range of 30 N to 200 N.

The left drive axle assembly 5 and the right drive axle assembly 6 each include a two-or-more-stage gear reducer. The gear reducer includes an input shaft, an output shaft, and an intermediate shaft. Each of the left brake component and the right brake component is disposed on a non-output shaft of the gear reducer of the respective drive axle assembly. In some embodiments, the braking force is derived from the user's depression. Disposing the brake components on the output shaft (i.e., a drive wheel axle) would result in an overly hard brake. In this way, excessive force would be required to generate a sufficient braking force, rendering effective pedal-initiated braking impractical. Therefore, the brake components are generally not disposed on the output shaft.

In the present embodiment, each of the left brake component and the right brake component is disposed on the intermediate shaft of the gear reducer of the respective drive axle assembly. There is a predetermined transmission ratio relationship among the input shaft, the intermediate shaft, and the output shaft. In some other embodiments, each of the brake components may be disposed on the input shafts of the gear reducer of the respective drive axle assembly. However, such a configuration would result in excessive brake sensitivity. That is, a slight depression of the pedal assembly may generate excessive braking force, which may result in sudden braking, making it difficult for the user to accurately control the depressing force when gradual deceleration is desired.

Since the drive axle assembly may include a multi-stage gear reducer, a reduction ratio between the intermediate shaft on which the left brake component or the right brake component is disposed and the corresponding output shaft ranges from 1 to 50. In some embodiments, the left drive axle assembly 5 and the right drive axle assembly 6 each include a 2-stage gear reducer, and the reduction ratio between the intermediate shaft on which the left brake component or the right brake component is disposed and the corresponding output shaft ranges from 3 to 6. Since the outdoor garden working vehicle according to some embodiments is provided with a mowing mechanism 7 and is mainly used for lawn maintenance, the curb weight of a typical residential garden working vehicle is approximately 200 kilograms (kg) to 300 kg, and the curb weight of a commercial garden working vehicle is approximately 500 kg to 800 kg. Per calculation, if the brake disc 823 is disposed on the output shaft, the required braking torque would satisfy T≥150 Nm, which is relatively strenuous for an average user. In some embodiments, the 2-stage gear reducer allows the required braking torque, when the braking moment is applied to the intermediate shaft, to satisfy 30 Nm≤T≤100 Nm, yielding a reasonably modulated pedal load conducive to precise depression control.

It should be noted that in some other embodiments, if the mowing mechanism 7 is replaced with a functional attachment having a greater weight, resulting in a significant increase in the overall vehicle weight, to reduce the force required for depressing the pedal assembly, the brake components may be disposed on the corresponding input shafts, respectively, or a gear reducer with a larger reduction ratio may be used with the brake component being disposed on an intermediate shaft close to the input shaft.

Each of the left brake component and the right brake component includes a brake caliper 822 mounted on the respective drive axle assembly. The brake caliper 822 includes a caliper hydraulic cylinder 8221, a caliper piston rod 8223, and a friction pad 8222. A brake disc 823 is fixedly connected to a shaft on which the left brake component or the right brake component is disposed. When the pedal assembly is depressed by the user, the brake caliper 822 is pressed against the brake disc 823 to generate a braking force. In this process, the foot brake pump 811 is connected to the caliper hydraulic cylinder 8221 via the hydraulic tube 810 and supplies the braking pressure, and the caliper piston rod 8223 moves relative to the caliper hydraulic cylinder 8221 to drive the friction pad to move and press against the brake disc 823 to generate the braking force.

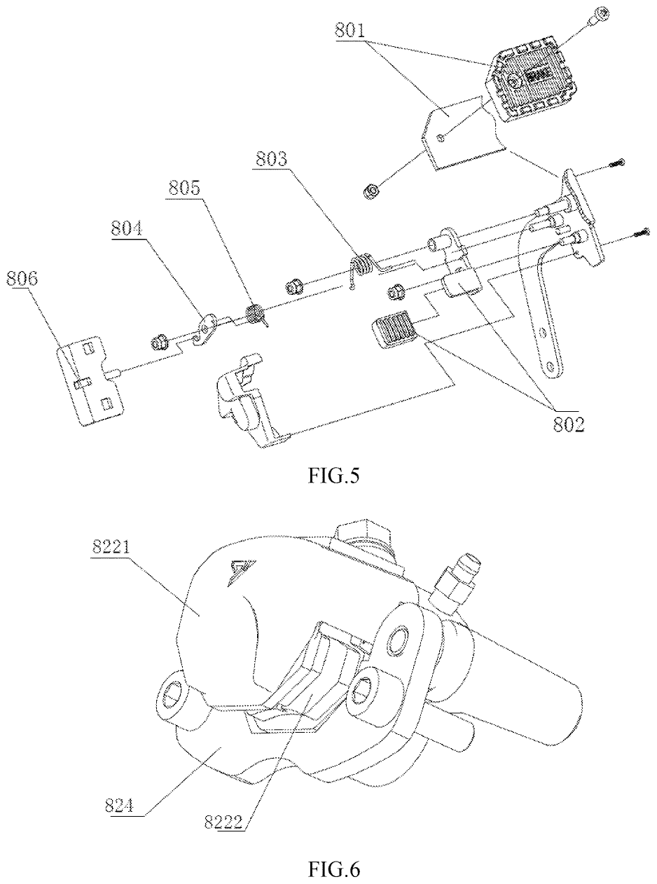

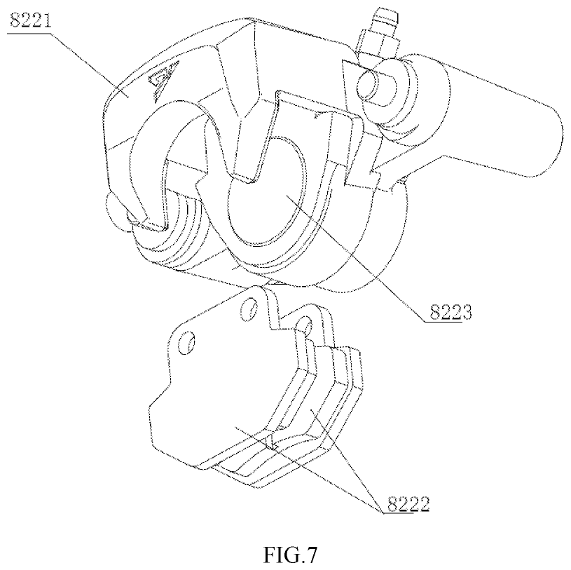

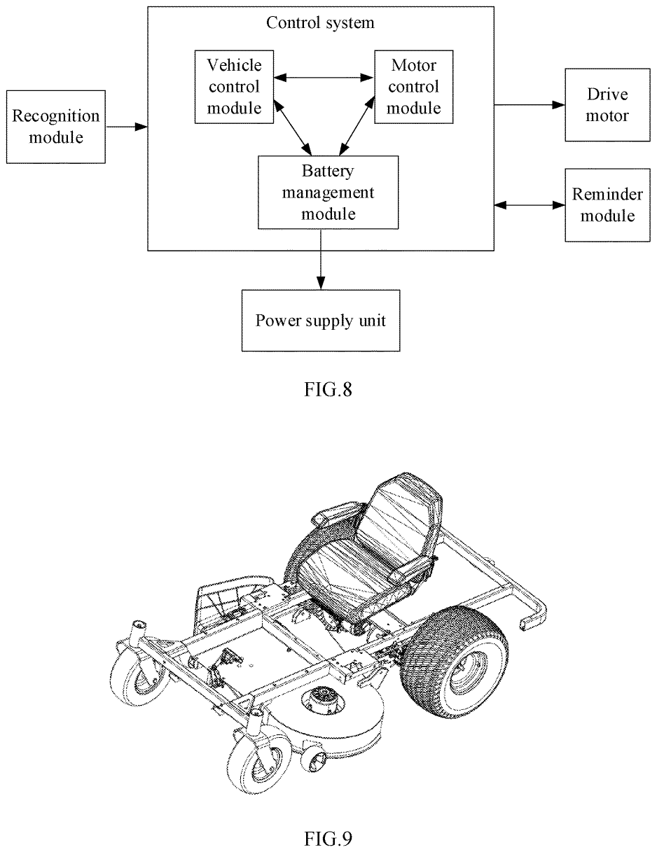

Referring to FIGS. 6 to 7, the brake caliper 822 of each of the left brake component and the right brake component has a single cylinder bore, meaning that the brake component includes a caliper hydraulic cylinder 8221 only on one side of the brake disc 823. Generally, each brake component includes only one caliper hydraulic cylinder 8221 and one caliper piston rod 8223, and the caliper hydraulic cylinder 8221 is slidably mounted to the frame 1 or the corresponding gear reducer. The friction pad 8222 includes a movable friction pad and a stationary friction pad. The movable friction pad is fixed to the caliper piston rod 8223 and located on one side of the brake disc 823, and the stationary friction pad is disposed on another side of the brake disc 823. When the braking pressure is supplied to the caliper hydraulic cylinder 8221 by the foot brake pump 811, the movable friction pad and the stationary friction pad are pushed by the caliper piston rod 8223 to clamp the brake disc 823. In this process, the movable friction pad is first brought into contact with the brake disc 823, and then the caliper piston rod 8223 continues to move, causing the stationary friction pad to move toward the brake disc 823 until the friction pad 8222 is brought into contact with the brake disc 823 and generate the braking force.

In some other embodiments, the brake caliper 822 of each of the left brake component and the right brake component may have two cylinder bores, meaning that the brake component includes caliper hydraulic cylinders 8221 respectively on both sides of the brake disc 823. Generally, each brake component includes two caliper hydraulic cylinders 8221 respectively located on two sides of the brake disc 823, and two friction pads 8222 are fixed to the caliper piston rods 8223 and located on two sides of the brake disc 823. When the braking pressure is supplied to the caliper hydraulic cylinders 8221 by the foot brake pump 811, the two friction pads are pushed by the caliper piston rods 8223 to clamp the brake disc 823. It should be noted that if positions of the two caliper hydraulic cylinders 8221 are fixed, positions of the caliper hydraulic cylinders 8221 need to be precisely adjusted to maintain distances from the two friction pads 8222 to the brake disc 823 equal; otherwise, the friction pad 8222 on one side of the brake disc 823 may not effectively abut against the brake disc 823, resulting in unsatisfactory deceleration performance. To address this problem, the caliper hydraulic cylinders 8221 are generally slidably mounted to the frame 1 or the corresponding gear reducer, thereby eliminating the need for precise adjustment of the positions of the caliper hydraulic cylinders 8221.

A floating mounting bracket 824 is fixed to the frame 1 or the corresponding gear reducer, and the caliper hydraulic cylinder 8221 is slidably connected to the floating mounting bracket 824, so as to achieve a floating mounting of the caliper hydraulic cylinder 8221 on the frame 1.

The brake disc 823 has a thickness of 2 millimeter (mm) to 6 mm and a diameter of 60 mm to 300 mm. The brake caliper 822 has a hydraulic pressure range of 2 megapascal (MPa) to 40 MPa, and the caliper piston rod 8223 has a piston stroke of 0.5 mm to 20 mm. The foot brake pump 811 has a cylinder rod diameter of 5 mm to 30 mm, the caliper hydraulic cylinder 8221 has a diameter of 5 mm to 40 mm, and the foot brake pump 811 has a cylinder rod stroke of 5 mm to 100 mm. The components with reasonable dimensions together achieve an effective braking effect. In some embodiments, the foot brake pump 811 has a cylinder rod stroke of 10 mm to 60 mm.

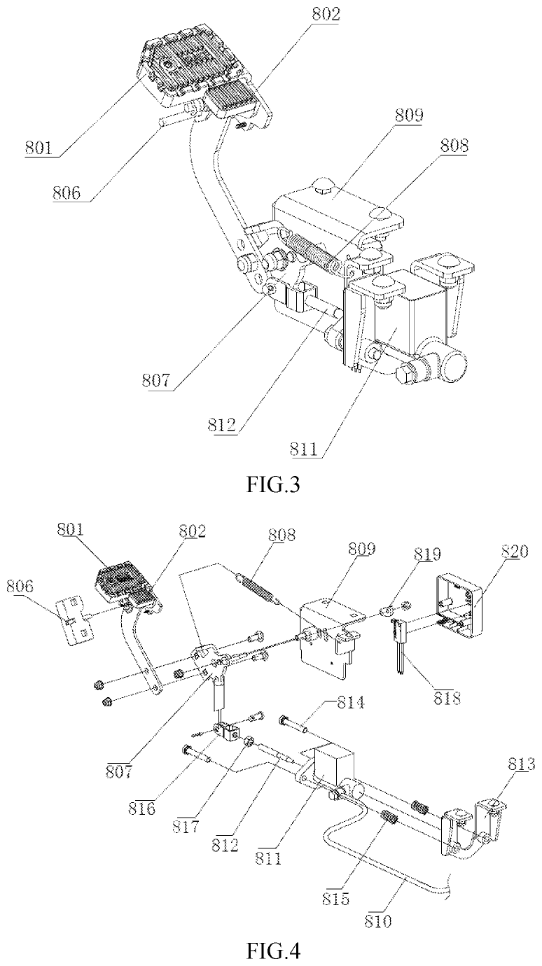

Referring to FIGS. 3 to 4, the parking and service brake assembly further includes a rotation plate 807 and a brake spring 808. The rotation plate 807 is rotatably connected to the frame 1. The pedal assembly is fixedly connected to the rotation plate 807. Two ends of the brake spring 808 are respectively connected to the frame 1 and the rotation plate 807. A threaded push rod 812 is connected to the rotation plate 807. The rotation plate 807 is configured to rotate and pull, when the pedal assembly is depressed by the user, the brake spring 808, pushing the threaded push rod 812 to press against the foot brake pump 811 to generate the braking force. In some embodiments, the brake spring 808 is a brake tension spring. When the pedal assembly is depressed by the user, the brake tension spring is rotated and stretched by the rotation plate 807, and a pulling force is provided by the brake tension spring to restore the pedal assembly.

In some other embodiments, the brake spring 808 may also be a brake torsion spring or a brake compression spring. In a case where the brake torsion spring is used, when the pedal assembly is depressed by the user to rotate the rotation plate 807, one end of the brake torsion spring rotates synchronously with the rotation plate 807. In a case where the brake compression spring is used, when the pedal assembly is depressed by the user, the brake compression spring is rotated and compressed by the rotation plate 807.

To facilitate the arrangement of the brake spring 808, the parking and service brake assembly further includes a fixing bracket 809 fixedly connected to the frame 1. The rotation plate 807 is rotatably connected to the fixing bracket 809. Two ends of the brake tension spring are respectively connected to the fixing bracket 809 and the rotation plate 807.

Referring to FIGS. 2 to 5, the pedal assembly includes a main pedal 801, an auxiliary pedal 802, a hook plate 804, and a hook plate torsion spring 805. A limit rod 806 is fixedly connected to the frame 1. The hook plate 804 is rotatably connected to the main pedal 801. When the main pedal 801 is depressed by the user, the hook plate 804 is hooked onto the limit rod 806 to bring the braking module into a parking state. In the parking state, the braking module can continuously provide a relatively large braking force. When the pedal assembly is released by the user in this state, the state of the braking module does not change, and the entire vehicle remains in place under the braking force. The hook plate torsion spring 805 is disposed on a rotation shaft of the hook plate 804 and is configured to apply a spring force to the hook plate 804 to maintain the hook plate 804 hooked onto the limit rod 806 in the parking state, so as to prevent the hook plate 804 from separating from the limit rod 806 due to slight vibrations. A holding force for the hook plate torsion spring 805 to maintain the contact between the hook plate 804 and the limit rod 806 ranges from 5 N to 30 N. In the present embodiment, the holding force for the hook plate torsion spring 805 to maintain the contact between the hook plate 804 and the limit rod 806 is 7 N.

When the main pedal 801 moves upon the user's depression, at least one of two surfaces that are first brought into contact with each other between the hook plate 804 and the limit rod 806 is curved. The depression of the main pedal 801 by the user causes the hook plate 804 to abut against the limit rod 806 to rotate the hook plate 804, until an inner side of the hook plate 804 passes around the limit rod 806 and is hooked onto the limit rod 806, thereby achieving the parking operation.

The auxiliary pedal 802 is movably connected to the main pedal 801. Upon the depression of the auxiliary pedal 802 by the user, the hook plate 804 is separated from the limit rod 806. In an exemplary embodiment of the present disclosure, when the auxiliary pedal 802 is depressed by the user, the auxiliary pedal 802 moves and presses against the hook plate 804, causing the hook plate 804 to rotate away from the limit rod 806 and separate from the limit rod 806. When the auxiliary pedal 802 is depressed by the user, a maximum rotation angle through which the hook plate 804 shifts from a hooked state in which the hook plate 804 is hooked onto the limit rod 806 to a separated state in which the hook plate 804 is separated from the limit rod 806 upon the depression of the auxiliary pedal 802 ranges from 5° to 30°.

In some embodiments, the auxiliary pedal 802 is rotatably connected to the main pedal 801, and the rotation angle of the auxiliary pedal 802 upon the depression of the auxiliary pedal 802 by the user ranges from 0° to 90°.

In some other embodiments, the auxiliary pedal 802 may also be slidably disposed on the main pedal 801, as long as the auxiliary pedal 802 can be depressed to drive the hook plate 804 to rotate and separate from the limit rod 806. The specific arrangement is not limited to the above-described rotational or sliding connection.

In some embodiments, the main pedal 801 and the auxiliary pedal 802 can be depressed simultaneously or separately with a single foot. That is, the auxiliary pedal 802 is close to the main pedal 801, and is generally disposed on one side of the main pedal 801. An auxiliary pedal torsion spring 803 is disposed at a hinge between the auxiliary pedal 802 and the main pedal 801. The auxiliary pedal 802 is biased by the auxiliary pedal torsion spring 803 to remain in a non-pressing state relative to the hook plate 804 when not depressed, preventing the vehicle from shaking due to external forces or user action and inadvertently striking the hook plate 804, which could result in release of the parking state. In some embodiments, a depressing force applied by the user to the auxiliary pedal 802 to separate the hook plate 804 from the limit rod 806 is 3 N to 100 N, which is less than the force required to depress the main pedal 801 to bring the braking module 8 into the parking state.

Similar to the brake spring 808 described above, the hook plate torsion spring 805 and the auxiliary pedal torsion spring 803 in the present disclosure may also be replaced with compression springs or tension springs. A person skilled in the art may select an appropriate specific arrangement according to the actual situation, and details thereof are not described herein.

Referring to FIGS. 2 to 5, in some embodiments, the auxiliary pedal 802 is disposed at a rear side of the main pedal 801, such that upon depression by the user, the ball of the foot acts on the main pedal 801 and the heel acts on the auxiliary pedal 802. Since users generally habitually apply more force with the ball of the foot when depressing, the depressing force on the main pedal 801 is greater than that on the auxiliary pedal 802, making this arrangement more consistent with user habits.

Referring to FIG. 8, the outdoor garden working vehicle further includes a recognition module, a control system, and a reminder module.

The recognition module is configured to detect whether the main pedal 801 is depressed. The control system includes a vehicle control module, a motor control module, and a battery management module. The vehicle control module, the motor control module, and the battery management module are in signal communication with one another. The battery management module is in signal communication with the power supply unit. The motor control module is in signal communication with the drive motors. The control system is configured to control, in response to detecting depression of the main pedal 801 by the recognition module, the left drive motor and the right drive motor to stop rotating, thereby achieving a linkage between the drive motors and the braking module 8. This avoids the drive motors from keeping outputting power when braking is applied, which would otherwise lead to increased braking distance, overheating of the brake disc 823 or even dry burning, overheating of the drive motors, and other faults. The recognition module is further configured to send a braking state reminder to the user via the reminder module, alerting the user that the vehicle is currently in a braking state.

Referring to FIG. 4, the recognition module in some embodiments includes a micro switch 818 disposed on the frame. A switch pressing plate 819 is fixed to the rotation plate 807. When the main pedal 801 is in a naturally released state, the switch pressing plate 819 presses the micro switch 818. When the main pedal 801 is depressed by the user to rotate the rotation plate 807, the switch pressing plate 819 moves out of contact with the micro switch 818, whereupon the micro switch 818 triggers the left drive motor and the right drive motor to stop rotating. In some embodiments, as long as the main pedal 801 is depressed by the user to cause it to rotate, the switch pressing plate 819 will disengage from the micro switch 818, thereby triggering the recognition module to control the drive motors to stop rotating.

A switch box 820 is fixedly disposed on the fixing bracket 809. The micro switch 818 and the switch pressing plate 819 are both mounted in the switch box 820. The switch box 820 provides protection for the micro switch 818 and the switch pressing plate 819, preventing external objects from contacting them and generating erroneous signals.

A hydraulic brake force damping adjustment mechanism is provided at the foot brake pump 811, and is configured to enable the pedal assembly to be further depressed when hydraulic oil inside the foot brake pump 811 is compressed to the limit. When the hydraulic oil inside the foot brake pump 811 is compressed to the limit, the friction pad 8222 of the brake caliper 822 is already in close abutment with the brake disc 823, and the piston rod inside the foot brake pump 811 cannot be further pressed to continue moving within the cylinder. Without the damping adjustment mechanism, when the hydraulic oil is compressed to the limit, the pedal assembly cannot be further depressed, and thus the user would feel that the pedal assembly is “very hard,” resulting in a degraded depressing experience. With the damping adjustment mechanism, after the hydraulic oil is compressed to the limit, further depression compresses the damping adjustment mechanism, and the user can feel that the damping resistance gradually increases, but the gradually increasing damping resistance does not give the user a “very hard” feel, thereby improving the user experience.

The hydraulic brake force damping adjustment mechanism includes an oil pump bracket 813 and a damping member. The damping member is capable of elastic deformation when compressed. The oil pump bracket 813 is fixed to the frame 1. The damping member connects the foot brake pump 811 and the oil pump bracket 813. When the pedal assembly is further depressed after the hydraulic oil is compressed to the limit, the damping member deforms and applies a reverse elastic force to the foot brake pump 811.

The hydraulic brake force damping adjustment mechanism further includes a guide member connected to the foot brake pump 811. The guide member is configured to restrict the foot brake pump 811 to reciprocate only in a direction along which the foot brake pump 811 is pressed by the pedal assembly. The guide member serves to prevent the foot brake pump 811 from tilting when moving, ensuring that various components move in predetermined directions and avoiding abnormal force conditions caused by tilting.

In some embodiments, the damping member is a damping compression spring 815, and the guide member is a bolt 814. The bolt 814 sequentially passes through the foot brake pump 811 and the damping compression spring 815 and is threadedly connected to the oil pump bracket 813. The foot brake pump 811 is slidably sleeved on the bolt 814, and the bolt 814 limits a maximum distance between the foot brake pump 811 and the oil pump bracket 813. The damping compression spring 815 is disposed between the foot brake pump 811 and the oil pump bracket 813. When the pressing force applied by the threaded push rod 812 to the foot brake pump 811 is greater than the elastic force of the damping compression spring, the damping compression spring is further compressed, and the foot brake pump 811 can move relative to the oil pump bracket 813.

The damping member has an initial damping force after being assembled. This initial damping force is slightly less than the pressing force applied by the threaded push rod 812 to the foot brake pump 811 when the vehicle is just completely braked (i.e., when the hydraulic oil is fully compressed). That is, during the stage from the beginning of depressing the pedal assembly to the full compression of the hydraulic oil, the damping member has already begun to deform. When the pedal assembly is further depressed after the hydraulic oil is fully compressed, only the damping member continues to deform, and a rebound force applied to the user's foot by this deformation increases linearly. In this way, the required depressing force by the user from the beginning of depressing the pedal assembly to the point where further depression is impossible always increases gradually, eliminating an abrupt sharp increase in the depression force required for continued pedal travel of the pedal assembly, thereby further improving the user's pedal feel.

When the main pedal 801 is in a naturally released state, the damping compression spring is in a first state. When the hook plate 804 is hooked onto the limit rod 806, the damping compression spring 815 is in a second state. A compression amount of the damping compression spring 815 in the second state is greater than that in the first state. A difference in compression amount of the damping compression spring 815 between the second state and the first state ranges from 1 mm to 60 mm. This difference in compression amount is a distance by which the foot brake pump 811 moves, and a reasonable distance range also serves to improve the user's pedal feel.

In some other embodiments, the damping member may also be a torsion bar spring, an air spring, a hydro-pneumatic spring, a rubber spring, or various other types. A guiding function of the guide member may also be achieved by a guide rail or other limiting means. The arrangement is similar to that of the brake spring described above, and a person skilled in the art can perform simple adaptive assembly according to requirements to achieve the above effects.

An adjustment nut 817 is disposed between the threaded push rod 812 and the rotation plate 807. The adjustment nut 817 is connected to the rotation plate 807. The threaded push rod 812 is threadedly connected to the adjustment nut 817. An end of the threaded push rod 812 away from the adjustment nut 817 abuts against a piston rod of the foot brake pump 811. The threaded push rod 812 has a threaded portion configured to cooperate with the adjustment nut 817 to adjust a position of the threaded push rod 812 relative to the rotation plate 807, which reduces an idle stroke caused by mechanical cumulative errors and significantly shortens a response time of the foot brake pump. Referring to the drawings, to facilitate installation of the adjustment nut 817, in some embodiments, a first connection plate 816 is disposed on the rotation plate 807, and the adjustment nut 817 is rotatably connected to the first connection plate 816. Rotating the adjustment nut 817 can adjust a length of the threaded push rod 812 threaded into the first connection plate 816, thereby shortening the response time of the foot brake pump.

In some embodiments of the present disclosure, the outdoor garden working vehicle further includes a user seat 2 connected to the frame 1, allowing the user to sit rather than stand while driving, facilitating the user to free up both feet for depressing the pedal assembly.

In some embodiments, the outdoor garden working vehicle further includes a standing platform connected to the frame 1 for the user to stand on while driving, providing the user with better visibility.

In some embodiments, the present disclosure further provides a lawn mower. The lawn mower includes a frame 1, a left drive axle assembly 5, a right drive axle assembly 6, a mowing mechanism 7, a power supply unit, and a braking module. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The mowing mechanism 7 is disposed at a lower portion of the frame 1 for cutting ground vegetation. The power supply unit is electrically connected to the left drive motor, the right drive motor, and the mowing mechanism 7, and is configured to supply power to the left drive motor, the right drive motor, and the mowing mechanism 7. The braking module includes a parking and service brake assembly and a foot brake pump 811. The parking and service brake assembly includes a pedal assembly. The pedal assembly is hinged to the frame 1, and a lever is formed by the pedal assembly and the foot brake pump 811. The foot brake pump 811 is actuated through depression of the pedal assembly by the user to generate a braking force on the left drive axle assembly 5 and the right drive axle assembly 6.

In some embodiments, the present disclosure further provides an electric outdoor garden working vehicle. The electric outdoor garden working vehicle includes a frame 1, a left drive axle assembly 5, a right drive axle assembly 6, a mowing mechanism 7, a power supply unit, and a braking module. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The mowing mechanism 7 is disposed at a lower portion of the frame 1 for cutting ground vegetation. The power supply unit is electrically connected to the left drive motor, the right drive motor, and the mowing mechanism 7, and is configured to supply power to the left drive motor, the right drive motor, and the mowing mechanism 7. The braking module includes a parking and service brake assembly and a foot brake pump 811. The parking and service brake assembly includes a pedal assembly. The pedal assembly is hinged to the frame 1, and a lever is formed by the pedal assembly and the foot brake pump 811. The foot brake pump 811 is actuated through depression of the pedal assembly by the user to generate a braking force on the left drive axle assembly 5 and the right drive axle assembly 6.

In some embodiments, the present disclosure further provides a ride-on lawn mower. The ride-on lawn mower includes a frame 1, a seat, a left drive axle assembly 5, a right drive axle assembly 6, a mowing mechanism 7, a power supply unit, and a braking module. The seat is connected to the frame 1 and is configured for a user to sit on. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The mowing mechanism 7 is disposed at a lower portion of the frame 1 for cutting ground vegetation. The power supply unit is electrically connected to the left drive motor, the right drive motor, and the mowing mechanism 7, and is configured to supply power to the left drive motor, the right drive motor, and the mowing mechanism 7. The braking module includes a parking and service brake assembly. The parking and service brake assembly is configured to be depressed by a user to generate a braking force on the left drive axle assembly 5 and the right drive axle assembly 6. The parking and service brake assembly includes a pedal assembly. The pedal assembly includes a main pedal 801 and an auxiliary pedal 802. The main pedal 801 is configured to be depressed by the user to bring the braking module into either a braking state or a parking state, and the auxiliary pedal 802 is configured to be depressed by the user to release the braking module from the parking state.

In some embodiments, the present disclosure further provides an outdoor garden working vehicle. The outdoor garden working vehicle includes a frame 1, a left drive axle assembly 5, a right drive axle assembly 6, a working mechanism, a power supply unit, and a braking module. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The working mechanism is disposed at a lower portion of the frame 1 and is configured to perform outdoor work on the ground. The power supply unit is electrically connected to the left drive motor, the right drive motor, and the working mechanism, and is configured to supply power to the left drive motor, the right drive motor, and the working mechanism. The braking module includes a parking and service brake assembly. The parking and service brake assembly is configured to be depressed by the user to generate a braking force on the left drive axle assembly 5 and the right drive axle assembly 6. The parking and service brake assembly includes a pedal assembly. The pedal assembly includes a main pedal 801 and an auxiliary pedal 802. The main pedal 801 is configured to be depressed by the user to bring the braking module into either a braking state or a parking state, and the auxiliary pedal 802 is configured to be depressed by the user to release the braking module from the parking state.

In some embodiments, the present disclosure further provides an electric outdoor garden working vehicle. The electric outdoor garden working vehicle includes a frame 1, a left drive axle assembly 5, a right drive axle assembly 6, a working mechanism, a power supply unit, and a braking module. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The working mechanism is disposed at a lower portion of the frame 1 and is configured to perform outdoor work on the ground. The power supply unit is electrically connected to the left drive motor, the right drive motor, and the working mechanism, and is configured to supply power to the left drive motor, the right drive motor, and the working mechanism. The braking module includes a parking and service brake assembly and a foot brake pump 811. The parking and service brake assembly includes a pedal assembly. The pedal assembly is configured to press, when being depressed by the user, the foot brake pump 811 to generate a braking force on the left drive axle assembly 5 and the right drive axle assembly 6.

In some embodiments, the present disclosure further provides a ride-on outdoor garden working vehicle. The ride-on outdoor garden working vehicle includes a frame 1, a seat, a left drive axle assembly 5, a right drive axle assembly 6, a working mechanism, a power supply unit, and a braking module. The seat is connected to the frame 1 and is configured for a user to sit on. The left drive axle assembly 5 is mechanically coupled between a left drive motor and a left drive wheel 3, and is configured to transmit power from the left drive motor to the left drive wheel 3. The right drive axle assembly 6 is mechanically coupled between a right drive motor and a right drive wheel 4, and is configured to transmit power from the right drive motor to the right drive wheel 4. The working mechanism is disposed at a lower portion of the frame 1 and is configured to perform outdoor work on the ground. The power supply unit is electrically connected to the left drive motor, the right drive motor, and the working mechanism, and is configured to supply power to the left drive motor, the right drive motor, and the working mechanism. The braking module includes a parking and service brake assembly and a foot brake pump 811. The parking and service brake assembly includes a pedal assembly. The pedal assembly is configured to press, when being depressed by the user, the foot brake pump 811 to generate a braking force on the left drive axle assembly 5 and the right drive axle assembly 6. The parking and service brake assembly includes a pedal assembly. The pedal assembly includes a main pedal 801 and an auxiliary pedal 802. The main pedal 801 is configured to be depressed by the user to bring the braking module into either a braking state or a parking state, and the auxiliary pedal 802 is configured to be depressed by the user to release the braking module from the parking state.

Lawn mowers are mainly used for lawn maintenance. Compared with manual maintenance, they can effectively reduce costs. In particular, rechargeable lawn mowers, compared with traditional fuel-powered lawn mowers, have the advantages of all-weather zero emissions, zero fuel consumption, low noise, and simple maintenance (no gasoline, no engine oil, no air filter, no spark plug, no fuel storage, etc.). Rechargeable lawn mowers employ motors instead of fuel engines for the drive wheels, and the drive wheel motors can be independently controlled to achieve motion control such as straight travel, reverse travel, turning, and zero-turn, reducing the structural complexity of the entire vehicle and making vehicle control more flexible.

In existing rechargeable lawn mowers, the motor output shaft is connected to the wheels through a mechanism. When the ride-on lawn mower is stationary (not controlled) and an external force is used to push or pull it (towing), the rotation of the wheels drives the motor to rotate, bringing the motor into a power generation state. If a towing speed is very high, i.e., a vehicle speed is very high, a voltage generated by the electric motor will also be very high. When the voltage exceeds a maximum voltage that the controller can withstand, the controller will be damaged and fail. Therefore, current rechargeable lawn mowers generally prohibit towing. However, in actual use, there are inevitably scenarios where long-distance transfer requires towing, such as moving, off-site maintenance, etc. This is especially true for commercial lawn mowers, which have higher transfer frequencies. This requires the user to employ a special vehicle with lifting equipment to transfer the lawn mower, which is expensive and time-consuming.

In view of this, there is indeed a need to provide a zero-turn lawn mower capable of being towed, to overcome the defects existing in the related art.

FIGS. 9 to 13 show a zero-turn lawn mower according to some embodiments of the present disclosure. The zero-turn lawn mower includes: a frame, a drive axle assembly, a mowing mechanism, and a power supply unit.

The drive axle assembly includes a left drive axle assembly and a right drive axle assembly. Each of the left drive axle assembly and the right drive axle assembly is mechanically coupled between a drive motor 1001 and a drive wheel on a corresponding side where the axle assembly is located, and is configured to transmit power from the drive motor 1001 to the drive wheel. Referring to FIG. 9, the drive axle assembly is disposed at a rear portion of the lawn mower, such that rear wheels of the lawn mower serve as drive wheels, and front wheels of the lawn mower serve as caster wheels, thereby achieving a zero-turn function and improving the operational performance of the lawn mower.

The mowing mechanism is disposed at a lower portion of the frame and is configured to cut ground vegetation. In an exemplary embodiment of the present disclosure, the left and right drive wheels are located at a rear portion of the mowing mechanism 7. It should be noted that the mowing mechanism 7 should not be narrowly interpreted as a mechanism capable only of mowing grass; it may also be replaced with other functional attachments, such as snowplow or snow blower attachments. A person skilled in the art should be able to adaptively replace various functional attachments without creative effort, and all such replacements should be included within the scope of the present disclosure.

The power supply unit is electrically connected to the drive motors 1001 and the mowing mechanism, and is configured to supply power to the drive motors 1001 and the mowing mechanism. In some embodiments, the power supply unit is a battery pack. In some other embodiments, a combination of an internal combustion engine and a battery may also be used. In such a configuration, the internal combustion engine burns fuel to generate electricity via a generator to charge the battery, and power is then supplied to various components of the lawn mower by the battery.

The drive axle assembly includes a housing and a plurality of shafts. At least one of the shafts is connected to a neutral mechanism. The neutral mechanism is controllable to bring the drive axle assembly into a neutral state or an engaged state. In the engaged state, the drive axle assembly transmits power from the drive motor 1001 to the drive wheel, such that the drive motor 1001 can drive the lawn mower forward or backward. In the neutral state, the drive axle assembly does not transmit power from the drive motor 1001 to the drive wheel. In this state, operation of the drive motor 1001 cannot move the lawn mower. When the lawn mower is towed by a towing device, the drive wheels rotate due to contact with the ground; however, rotational power is not transmitted to the drive motor 1001, avoiding the motor from entering a power generation state, which thus avoids damage to the motor or controller.

The shafts include an input shaft 1003 and an output shaft 1005. The input shaft 1003 is mechanically coupled to the drive motor 1001, and the input shaft 1003 is rotated by the drive motor 1001. The output shaft 1005 is coupled between the input shaft 1003 and the drive wheel, and is configured to convey power from the drive motor 1001 to the drive wheel.

Referring to FIG. 14, the zero-turn lawn mower further includes a recognition module, a control system, and a reminder module. The recognition module is configured to recognize whether the drive axle assembly is in the neutral state. The control system includes a vehicle control module, a motor control module, and a battery management module. The vehicle control module, the motor control module, and the battery management module are in signal communication with one another. The battery management module is in signal communication with the power supply unit. The motor control module is in signal communication with the drive motors 1001. When it is detected by the recognition module that the drive axle assembly is in the neutral state, the recognition module sends a neutral state reminder to the user via the reminder module, clearly informing the user that the vehicle is currently in the neutral state. Accordingly, when the drive axle assembly is in the engaged state, the neutral state reminder disappears, and the user can know that the vehicle is not in the neutral state and can drive the lawn mower normally for mowing operations.

The neutral mechanism includes an operating portion and an action portion connected to each other. The action portion is capable of, under action of the operating portion, bringing the drive axle assembly into the neutral state or the engaged state. The operating portion is controlled by the user to move the action portion, thereby achieving a gear change.

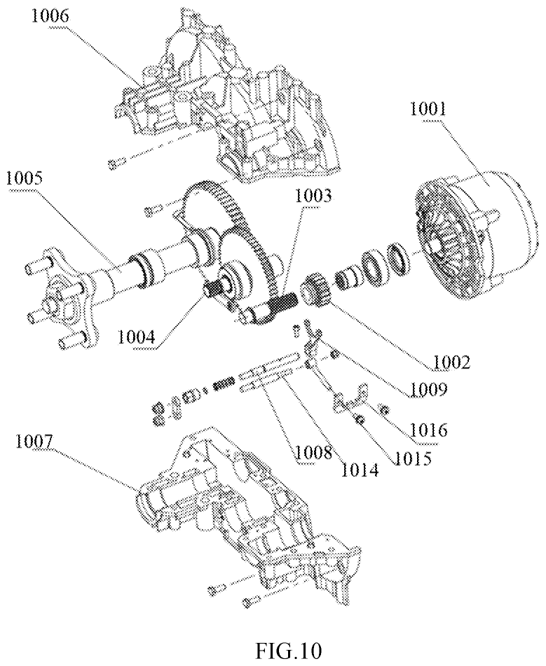

Referring to FIG. 10, in some embodiments, a sliding gear 1002 is disposed on a shaft on which the neutral mechanism is provided. The sliding gear 1002 is capable of transmitting torque and being slidable along the shaft. That is, when the shaft rotates, the sliding gear 1002 rotates synchronously with the shaft. The sliding gear 1002 can slide along the shaft. A fixed gear is disposed on another shaft adjacent to the shaft on which the neutral mechanism is provided. The operating portion may be controlled to drive the sliding gear 1002 to slide along its shaft to engage or disengage the sliding gear 1002 with or from the fixed gear. When the sliding gear 1002 and the fixed gear are engaged with each other, the drive axle assembly is in the engaged state. When the sliding gear 1002 and the fixed gear are disengaged from each other, the drive axle assembly is in the neutral state.

The sliding gear 1002 is in splined engagement with its respective shaft. That is, the splined connection between the sliding gear 1002 and the shaft enables the sliding gear 1002 and the shaft to rotate synchronously. For example, a spline may be provided on the shaft, and a spline groove (or a groove with other shapes mating with the spline) may be provided on the sliding gear 1002, such that the spline can slide within the spline groove.

In an exemplary embodiment of the present disclosure, referring to FIG. 10, an inner bore of the sliding gear 1002 is provided with an internal spline, and the shaft, on which the sliding gear 1002 is slidably connected, is provided with an external spline mating with the internal spline. Axial sliding of the sliding gear 1002 along the external spline can allow the sliding gear 1002 to be switched between a state where the sliding gear 1002 engages with the fixed gear and a state where the sliding gear 1002 disengages from the fixed gear, thereby switching the drive axle assembly between the engaged state and the neutral state.

Referring to FIGS. 10 to 13, the action portion includes a neutral shifting member. Sliding of the neutral shifting member along the respective shaft drives the sliding gear 1002 to slide to switch the drive axle assembly between the engaged state and the neutral state.

In some embodiments, a shifting groove is formed circumferentially in the sliding gear 1002, and one end of the neutral shifting member is engaged in the shifting groove. The neutral shifting member may include a neutral shifting fork 1009. An end of the neutral shifting fork 1009 proximate to the sliding gear 1002 is bifurcated and extends into the shifting groove. The sliding gear 1002 may be rotating, however, since the shifting groove is an annular structure, when the neutral shifting fork 1009 is engaged in the shifting groove, the sliding gear 1002 will not disengage from the neutral shifting fork 1009 regardless of its rotational position. Moreover, when the neutral shifting fork 1009 slides along the shaft, the sliding gear 1002 will slide synchronously with the neutral shifting fork 1009.

To facilitate assembly of the neutral shifting fork 1009 and the shifting groove, an end of the neutral shifting fork 1009 connected to the shifting groove is provided with an arcuate outer edge, and a central angle of the arcuate outer edge is less than or equal to 180°.

In some embodiments, a protrusion is formed circumferentially on the sliding gear 1002, and one end of the neutral shifting member is engaged with the protrusion. The neutral shifting member may be a neutral shifting rod. An end of the neutral shifting rod proximate to the sliding gear 1002 is provided with a slot that engages with the protrusion, and the neutral shifting rod is operated to cause the sliding gear 1002 to slide.

Referring to FIGS. 10 to 13, in some embodiments of the present disclosure, a sliding rod 1008 is connected to the neutral shifting fork 1009, and the sliding rod 1008 is slidably connected to a housing of the gear reducer. That is, the neutral shifting fork 1009 can slide relative to the housing of the gear reducer. As shown in FIG. 10, the housing of the gear reducer includes an upper housing 1006 and a lower housing 1007.

To facilitate control of the operating portion, the operating portion includes the sliding rod 1008. The sliding rod 1008 extends through a side wall of the housing and is connected to a pull rod 1014 located outside the housing. The pull rod 1014 is provided with a handle 1015 for manual grasping.

Since lubricating oil is generally provided in the gearbox to lubricate the gears, an O-ring 1011 is provided on the sliding rod 1008 to seal the connection between the housing and the sliding rod 1008. Referring to FIG. 10, for ease of installation, an annular screw plug 1012 is generally installed on the housing of the gearbox via fine threads, and the sliding rod 1008 extends through the screw plug 1012, with the O-ring 1011 sealing the connection between the sliding rod 1008 and the screw plug 1012.

A spring 1010 is sleeved on the sliding rod 1008. Two ends of the spring 1010 are respectively connected to the housing and an outer wall of the sliding rod 1008. The sliding rod 1008 is biased by the spring 1010 with a spring force tending to move the sliding rod 1008 to a state where the drive axle assembly is in the neutral state or the engaged state. This prevents the sliding gear 1002 from being only partially engaged with the fixed gear along the axial direction of the shaft. If the sliding gear 1002 is only partially engaged with the fixed gear, damage is likely to occur during power transmission due to excessive local pressure on the gears.

A limiting plate 1016 is fixedly connected to an exterior of the housing. The limiting plate 1016 is configured to limit the handle 1015 to bring the drive axle assembly into the neutral state or the engaged state, i.e., to enable the drive axle assembly to stably remain in a predetermined state. In an exemplary embodiment of the present disclosure, the limiting plate 1016 has two limiting grooves 10162. When the handle 1015 is engaged in one of the limiting grooves 10162, the drive axle assembly is in the neutral state. When the handle 1015 is engaged in the other one of the limiting grooves 10162, the drive axle assembly is in the engaged state. The user can determine whether the drive axle assembly is in the neutral state or the engaged state based upon a position of the handle 1015. In addition, the handle 1015 is abutted against a side wall of the limiting groove 10162 by the spring 1010, i.e., the handle 1015 experiences a predetermined damping when sliding along the side wall of the limiting groove 10162. Therefore, the limiting groove 10162 also provides a predetermined limiting effect on the handle 1015, preventing the handle 1015 from easily disengaging from the corresponding limiting groove 10162.

The limiting plate 1016 is provided with a slide channel 10161 connecting the two limiting grooves 10162. The handle 1015 is slidable along the slide channel 10161 from one limiting groove 10162 to the other limiting groove 10162, thereby switching the gear state of the drive axle assembly.

The limiting plate 1016 is provided with a retaining member to prevent the handle 1015 from disengaging from the limiting groove 10162 due to vibration. In some embodiments, the retaining member includes a limiting protrusion 10163 provided on a side wall of the limiting groove 10162. The handle 1015, when in the limiting groove 10162, is prevented from directly sliding into the slide channel 10161 by a combined action of the spring 1010 and the limiting protrusion 10163. That is, the handle 1015 abuts against the side wall of the limiting groove 10162 under the action of the spring 1010, and in this abutting state, the handle 1015 is blocked by the limiting protrusion 10163 and cannot slide into the slide channel 10161. At this point, the handle 1015 may be manually pulled by the user to compress the spring 1010 until the handle 1015 bypasses the limiting protrusion 10163, after which the handle 1015 is permitted to slide into the slide channel 10161.

A second connection plate 1013 is jointly connected to the sliding rod 1008 and the pull rod 1014. The second connection plate 1013 is located outside the housing. The second connection plate 1013 is configured to stably connect the handle 1015 and the sliding rod 1008, ensuring that the sliding rod 1008 moves synchronously with the pull rod 1014. The sliding rod 1008 moves synchronously when the handle 1015 moves linearly. To ensure that the neutral shifting fork 1009 remains connected to the sliding gear 1002, the sliding rod 1008 should not rotate. Therefore, the handle 1015 is rotatably connected to the pull rod 1014, and the axial movement of the handle 1015 along the pull rod 1014 drives the pull rod 1014 to move synchronously, i.e., the linear movement of the handle 1015 correspondingly moves the sliding rod 1008 synchronously.

In some embodiments, the handle 1015 may be replaced with an electric linear actuator. In an exemplary embodiment of the present disclosure, the sliding rod 1008 extends through a side wall of the housing, and the electric linear actuator connected to the sliding rod 1008 is disposed outside the housing. The electric linear actuator may be controlled to extend and retract to drive the sliding rod 1008 to move, thereby switching the drive axle assembly between the neutral state and the engaged state. In this way, gear switching via the electric linear actuator is achieved.

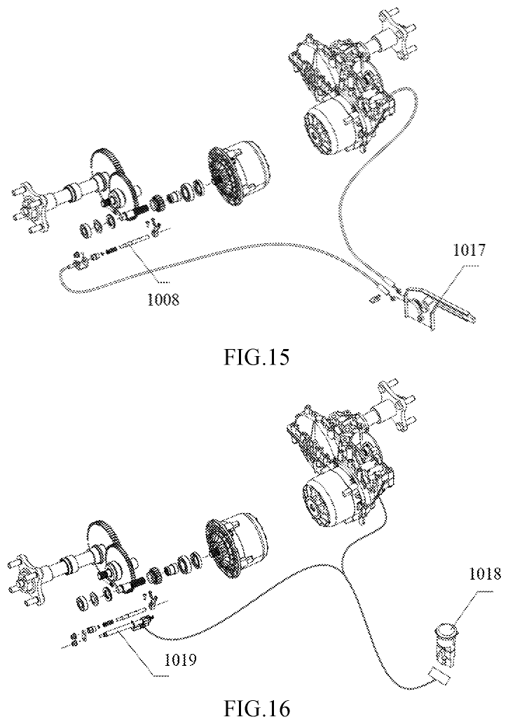

Referring to FIG. 15, in some embodiments, gear switching may also be controlled via a hand brake cable. In an exemplary embodiment of the present disclosure, the sliding rod 1008 extends through a side wall of the housing. The zero-turn lawn mower further includes a hand brake 1017 and a hand brake cable. The hand brake cable is connected to the sliding rod 1008. Operating the hand brake 1017 to move the hand brake cable causes the sliding rod 1008 to move therewith, thereby switching the drive axle assembly between the neutral state and the engaged state.

Referring to FIG. 16, in some embodiments, gear switching may also be controlled via an electric linear actuator 1019. In an exemplary embodiment of the present disclosure, the sliding rod 1008 extends through a side wall of the housing. The zero-turn lawn mower further includes a control switch 1018 and an electric linear actuator 1019. The electric linear actuator 1019 is connected to the sliding rod 1008. Manipulating the control switch 1018 causes the electric linear actuator 1019 to extend and retract to move the sliding rod 1008 with the electric linear actuator 1019, thereby switching the drive axle assembly between the neutral state and the engaged state.

Referring to FIG. 10, in some embodiments of the present disclosure, the shaft on which the sliding gear 1002 is disposed is parallel to the shaft on which the fixed gear is disposed. The sliding gear 1002 and the fixed gear are both spur gears. The sliding gear 1002 slides axially along the fixed gear until engagement or disengagement is achieved.

In some embodiments of the present disclosure, the shaft on which the sliding gear 1002 is disposed is not parallel to the shaft on which the fixed gear is disposed. The sliding gear 1002 and the fixed gear are both bevel gears. The bevel gears not only achieve the same engagement and disengagement effects but also improves positional layout flexibility of the shaft carrying the sliding gear 1002 to an opposite extent. In this embodiment, there is no need to ensure that the shaft of the sliding gear 1002 and the shaft of the fixed gear are parallel; they can be arranged at any angle within a common plane. This expands the layout options for the motor and the drive axle assembly, facilitating addition of other functional components around the drive axle or the motor by a person skilled in the art.

In the embodiments of the present disclosure, the sliding gear 1002 may be disposed on the input shaft 1003, and the fixed gear may be disposed on the output shaft 1005. In some other embodiments of the present disclosure, the fixed gear may be disposed on the input shaft 1003, and the sliding gear 1002 may be disposed on the output shaft 1005. Furthermore, the plurality of shafts further includes one or more intermediate shafts 4 disposed between the input shaft 1003 and the output shaft 1005. The intermediate shafts 4 are capable of transmitting power from the input shaft 1003 to the output shaft 1005. A common drive axle housing is generally a gear reducer. In general, the greater the number of the intermediate shafts 4, the greater the reduction ratio of the gearbox. For example, a gearbox with one intermediate shaft 1004 is a 2-stage reduction unit, and a gearbox with two intermediate shafts 4 is a 3-stage reduction unit.

When the drive axle assembly includes an intermediate shaft 1004, if the sliding gear 1002 is disposed on the input shaft 1003, the fixed gear may be disposed on the intermediate shaft 1004 adjacent to the input shaft 1003. In some other embodiments of the present disclosure, the sliding gear 1002 may be disposed on the output shaft 1005, and the fixed gear may be disposed on the intermediate shaft 1004 adjacent to the output shaft 1005. In some other embodiments of the present disclosure, the sliding gear 1002 may be disposed on one of the intermediate shafts 4, and the fixed gear may be disposed on an adjacent intermediate shaft 1004, the input shaft 1003, or the output shaft 1005.

Referring to FIG. 10, in some embodiments of the present disclosure, the drive axle assembly employs a 2-stage gear reducer, with one intermediate shaft 1004. The sliding gear 1002 is disposed on the input shaft 1003, and the fixed gear is disposed on the intermediate shaft 1004. Since an outer end surface of the input shaft 1003 is relatively close to a tire, disposing the handle 1015 of the neutral mechanism between the drive axle assembly and the tire would result in very compact space and inconvenient user operation. In addition, a plastic cover is generally mounted above the tire, and thus there is no operating space above a center plane of the drive axle assembly housing. Therefore, in some embodiments, the handle 1015 is located, in a horizontal direction, within an area inside an outer end surface of the housing, and, in a vertical direction, within an area below a center plane of the housing. This increases the operating space and simplifies the difficulty of operation. Moreover, since the user does not normally touch the location of the handle 1015 during normal operation, the probability of unintended touching of the handle 1015 causing a gear error is reduced.

In some embodiments, the drive axle assembly may also employ a planetary gear reducer. The planetary gear reducer includes a sun gear, a ring gear, and a plurality of planetary gears. The ring gear is fixed to the housing. The plurality of planetary gears are jointly connected to a planetary carrier. The input shaft 1003 is connected to the sun gear, and the output shaft 1005 is connected to the planetary carrier. The shaft of the sun gear and the shaft of the planetary carrier are intermediate shafts 4. In this case, the sliding gear 1002 may be disposed on the shaft of the sun gear, and the fixed gear may be disposed on the shaft of the planetary gear.

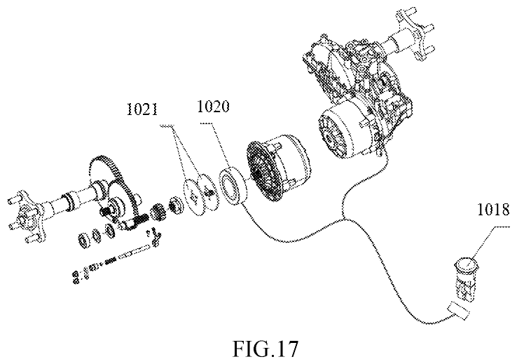

Referring to FIG. 17, in other embodiments, the neutral mechanism may also employ components other than the sliding gear 1002 and the fixed gear. For example, the neutral mechanism includes an operating portion and an action portion. The operating portion includes a control switch 1018. The action portion includes an electromagnetic clutch 1020. The shaft on which the electromagnetic clutch 1020 is provided is divided into a front shaft portion and a rear shaft portion arranged coaxially. The electromagnetic clutch 1020 includes two synchronizers 1021 respectively disposed on the front shaft portion and the rear shaft portion. The control switch 1018 can control the two synchronizers 1021 to abut against or separate from each other. When the two synchronizers 1021 abut against each other, power is transmitted between the front shaft portion and the rear shaft portion, and the drive axle assembly is in the engaged state. When the two synchronizers 1021 are separated, power transmission between the front shaft portion and the rear shaft portion is interrupted, and the drive axle assembly is in the neutral state.

In some embodiments, the present disclosure further provides an outdoor garden working vehicle including a frame, a drive axle assembly, a working mechanism, and a power supply unit. The drive axle assembly includes a left drive axle assembly and a right drive axle assembly. Each of the left drive axle assembly and the right drive axle assembly is mechanically coupled between a drive motor and a drive wheel on a corresponding side and is configured to transmit power from the drive motor to the drive wheel. The working mechanism is disposed at a lower portion of the frame for performing outdoor work on the ground. The power supply unit is electrically connected to the drive motors of the left drive axle assembly and the right drive axle assembly and the working mechanism, and is configured to supply power to the drive motors and the working mechanism.

The drive axle assembly includes a housing and a plurality of shafts. At least one of the shafts is connected to a neutral mechanism. The neutral mechanism may be controlled to bring the drive axle assembly into a neutral state or an engaged state. The drive axle assembly is configured to transmit power from the drive motor to the drive wheel in the engaged state, and stop transmitting power from the drive motor to the drive wheel in the neutral state. The plurality of shafts includes an input shaft and an output shaft. The input shaft is mechanically coupled to the drive motor, and the input shaft is rotated by the drive motor. The output shaft is coupled between the input shaft and the drive wheel, and is configured to output power from the drive motor to the drive wheel.

In some embodiments, the present disclosure further provides a ride-on garden working vehicle including a frame, a seat, a drive axle assembly, a working mechanism, and a power supply unit. The seat is connected to the frame for a user to sit on. The drive axle assembly includes a left drive axle assembly and a right drive axle assembly. Each of the left drive axle assembly and the right drive axle assembly is respectively mechanically coupled between a drive motor and a drive wheel on a corresponding side and is configured to transmit power from the drive motor to the drive wheel. The working mechanism is disposed at a lower portion of the frame for performing outdoor work on the ground. The power supply unit is electrically connected to the drive motors of the left drive axle assembly and the right drive axle assembly and the working mechanism, and is configured to supply power to the drive motors and the working mechanism.

The drive axle assembly includes a housing and a plurality of shafts. At least one of the shafts is connected to a neutral mechanism. The neutral mechanism may be controlled to bring the drive axle assembly into a neutral state or an engaged state. The drive axle assembly is configured to transmit power from the drive motor to the drive wheel in the engaged state, and stop transmitting power from the drive motor to the drive wheel in the neutral state. The plurality of shafts includes an input shaft and an output shaft. The input shaft is mechanically coupled to the drive motor, and the input shaft is rotated by the drive motor. The output shaft is coupled between the input shaft and the drive wheel, and is configured to output power from the drive motor to the drive wheel.

In summary, in the embodiments of the present disclosure, the neutral mechanism is provided, and the neutral mechanism includes an operating portion and an action portion. The operating portion is directly controlled by the user to control the action portion located inside the drive axle assembly, thereby bringing the drive axle into the neutral state or the engaged state. In the neutral state, rotation of the wheels cannot transmit power to the drive motor, thereby preventing the drive motor from being in a power generation state during towing and causing damage to the lawn mower. When the lawn mower is used normally for mowing, the drive axle assembly is in the engaged state, and the power of the drive motor can be effectively transmitted to the drive wheels, allowing the lawn mower to operate normally.

It is further noted that at least a portion of the power supply unit is detachably connected to the frame. The power supply unit includes a plurality of battery units detachable from the frame. The plurality of battery units may include at least one of a first-specification battery pack and a second-specification battery pack. Differences between the first-specification battery pack and the second-specification battery pack lie in, but are not limited to, battery pack capacity, voltage, internal resistance, weight, size, energy density, cell type, state of charge information, state of health information, and the like.

In some embodiments, the difference between the first-specification battery pack and the second-specification battery pack lies in the battery pack capacities. The capacity of the first-specification battery pack is greater than the capacity of the second-specification battery pack. The second-specification battery pack is configured to provide power to handheld garden tools. For example, the second-specification battery pack can power garden tools such as string trimmers, hedge trimmers, blowers, and chain saws. In addition, the second-specification battery pack can also power torque output tools such as drills and impact hammers, sawing tools such as circular saws, jigsaws, and reciprocating saws, or grinding tools such as angle grinders and sanders.

In some embodiments, the difference between the first-specification battery pack and the second-specification battery pack lies in the type of battery cells used. For example, the first-specification battery pack and the second-specification battery pack may use lithium iron phosphate cells or ternary lithium cells, respectively. The plurality of battery units in the power supply unit may also use nickel-chromium battery cells, lead-acid battery cells, graphene cells, or the like.

By configuring the plurality of battery units of the power supply unit to employ at least one of a first-specification battery pack and a second-specification battery pack, the multifunctional vehicle may be compatible with battery packs of different specifications, meeting high-power working requirements while also being adaptable to handheld electric garden tools, thereby improving operational flexibility for gardening personnel.

In some embodiments, the power supply unit further includes a battery compartment, a battery management system, etc. The battery compartment is used to accommodate the battery packs, and the battery management system is used to manage power supply from the battery packs to various components of the vehicle.

In some embodiments, the battery compartment and/or the battery management system is disposed on the frame. The battery pack is detachably disposed in the battery compartment, allowing the battery pack to be detachable and replaceable. The removed battery pack can be used for other electric garden tools. Moreover, the detachable battery pack design eliminates the need to wait for a long charging time when the vehicle's power is low or exhausted. In this way, the vehicle can quickly return to an operable state simply by replacing the battery pack.

In some embodiments, the battery compartment is detachably disposed on the frame, and the battery pack is accommodated in the battery compartment, i.e., the battery compartment as a whole can be separated from or integrated into the frame.

In some embodiments, the garden working mechanism is implemented as a cutting deck, and the garden working vehicle herein is a lawn mower. In addition, if the garden working mechanism is a snowplow attachment, the multifunctional garden vehicle is a snowplow. That is, the garden working mechanism serves as the main functional component of the multifunctional garden vehicle and can be changed according to user selection. At the same time, in some embodiments, the above-described garden working mechanism may also be a component that the user replaces according to actual needs. For example, replacing the cutting deck for mowing with a sweeping disc for sweeping would convert the lawn mower into a sweeper. In summary, replacing the garden working mechanism with any functional component according to user's needs should not be interpreted as departing from the protection scope of the present disclosure.

As described above, a working vehicle equipped with a power supply unit is a rechargeable working vehicle. Compared with existing fuel-powered working vehicles, rechargeable working vehicles have the advantages of all-weather zero emissions, zero fuel consumption, low noise, and simple maintenance (no gasoline, no engine oil, no air filter, no spark plug, no fuel storage, etc.). The powertrain of a rechargeable working vehicle uses an electric motor instead of a fuel engine, and the motors of the drive wheels can be independently controlled to achieve motion control such as straight travel, reverse travel, turning, and zero-turn, reducing the structural complexity of the entire vehicle and making vehicle control more flexible.

It should also be noted that the terms “including,” “comprising,” or any other variation thereof are intended to cover a non-exclusive inclusion, such that a process, method, article, or device that includes a list of elements includes not only those elements but also other elements not expressly listed, or elements inherent to such process, method, article, or device. Without further limitation, an element defined by the phrase “comprising a . . . ” does not exclude the presence of additional identical elements in the process, method, article, or device that includes the element.

The various embodiments in the present disclosure are described in a progressive manner, and the same or similar parts between the various embodiments may be referred to each other. Each embodiment focuses on the differences from other embodiments.

The present disclosure is not limited to the above-described specific embodiments. A person of ordinary skill in the art can readily appreciate that there are many alternative solutions for the brake device and the neutral mechanism of the present disclosure without departing from the principle and scope of the present disclosure. The scope of the present disclosure is defined by the claims.

What is claimed is:

1. An outdoor garden working vehicle, comprising:
a frame;
a left drive axle assembly and a right drive axle assembly, wherein the left drive axle assembly is mechanically coupled between a left drive motor and a left drive wheel and configured to transmit power from the left drive motor to the left drive wheel, and wherein the right drive axle assembly is mechanically coupled between a right drive motor and a right drive wheel and configured to transmit power from the right drive motor to the right drive wheel;
a working mechanism disposed at a lower portion of the frame for performing outdoor work on the ground;
a power supply unit electrically connected to the left drive motor, the right drive motor, and the working mechanism, and configured to supply power to the left drive motor, the right drive motor, and the working mechanism; and
a braking module, comprising:
a parking and service brake assembly and a foot brake pump, wherein the parking and service brake assembly comprises a pedal assembly, and wherein the pedal assembly is hinged to the frame, wherein a lever is formed by the pedal assembly and the foot brake pump, and wherein the foot brake pump is actuated through depression of the pedal assembly by a user to generate a braking force on the left drive axle assembly and the right drive axle assembly.

2. The outdoor garden working vehicle according to claim 1, wherein:
a mechanical advantage lever is formed by the pedal assembly and the foot brake pump, wherein when the pedal assembly is depressed by the user, a ratio of an input moment arm to an output moment arm of the mechanical advantage lever ranges from 1 to 20:1.

3. The outdoor garden working vehicle according to claim 2, wherein the braking module further comprises a hydraulic tube, a left brake component, and a right brake component,
wherein upon depression of the pedal assembly by the user, the foot brake pump is actuated to generate a braking pressure, and the braking pressure is simultaneously applied to the left brake component and the right brake component via the hydraulic tube to generate the braking force on the left drive axle assembly and the right drive axle assembly, enabling the left drive wheel and the right drive wheel to be braked; and
wherein a depressing force applied by the user to the pedal assembly for braking ranges from 20 N to 500 N.

4. The outdoor garden working vehicle according to claim 3, wherein:
each of the left drive axle assembly and the right drive axle assembly comprises a two-or-more-stage gear reducer, the gear reducer comprising an input shaft, an output shaft, and an intermediate shaft; and
each of the left brake component and the right brake component is disposed on a non-output shaft of the gear reducer of the respective drive axle assembly of the left drive axle assembly and the right drive axle assembly.

5. The outdoor garden working vehicle according to claim 4, wherein:
each of the left brake component and the right brake component comprises a brake caliper mounted on the respective drive axle assembly; and
a brake disc is fixedly connected to a shaft on which the left brake component or the right brake component is disposed, wherein when the pedal assembly is depressed by the user, the brake caliper is pressed against the brake disc to generate the braking force.

6. The outdoor garden working vehicle according to claim 5, wherein the brake caliper comprises a caliper hydraulic cylinder, a caliper piston rod, and a friction pad,
wherein when the foot brake pump is connected to the caliper hydraulic cylinder via the hydraulic tube to supply the braking pressure, the friction pad is pressed against the brake disc by the caliper piston rod to generate the braking force.

7. The outdoor garden working vehicle according to claim 6, wherein:
the brake caliper has a single cylinder bore, the caliper hydraulic cylinder being slidably mounted to the frame or the gear reducer of the respective drive axle assembly; and
the friction pad comprises a movable friction pad and a stationary friction pad, the movable friction pad being fixed to the caliper piston rod and located on one side of the brake disc, and the stationary friction pad being disposed on another side of the brake disc;
wherein when the braking pressure is supplied to the caliper hydraulic cylinder by the foot brake pump, the movable friction pad and the stationary friction pad are pushed by the caliper piston rod to clamp the brake disc.

8. The outdoor garden working vehicle according to claim 7, wherein a floating mounting bracket is fixed to the frame or the gear reducer of the respective drive axle assembly, the caliper hydraulic cylinder being slidably connected to the floating mounting bracket.

9. The outdoor garden working vehicle according to claim 2, wherein the parking and service brake assembly further comprises:
a rotation plate rotatably connected to the frame, wherein the pedal assembly is fixedly connected to the rotation plate, and wherein a threaded push rod is connected to the rotation plate; and
a brake spring, two ends of the brake spring being connected to the frame and the rotation plate, respectively,
wherein the rotation plate is configured to rotate and pull, when the pedal assembly is depressed by the user, the brake spring, pushing the threaded push rod to press against the foot brake pump to generate the braking force.

10. The outdoor garden working vehicle according to claim 9, wherein the brake spring is configured as a brake tension spring,
wherein when the pedal assembly is depressed by the user, the brake tension spring is rotated and stretched by the rotation plate.

11. The outdoor garden working vehicle according to claim 10, wherein the parking and service brake assembly further comprises a fixing bracket fixedly connected to the frame, the rotation plate being rotatably connected to the fixing bracket, and the brake tension spring having two ends respectively connected to the fixing bracket and the rotation plate.

12. The outdoor garden working vehicle according to claim 9, wherein:
the pedal assembly comprises a main pedal, an auxiliary pedal, a hook plate, and a hook plate torsion spring; and
a limit rod is fixedly connected to the frame,
wherein the hook plate is rotatably connected to the main pedal, wherein when the main pedal is depressed by the user, the hook plate is hooked onto the limit rod to bring the braking module into a parking state;
wherein the hook plate torsion spring is disposed on a rotation shaft of the hook plate and configured to apply a spring force to the hook plate to maintain the hook plate hooked onto the limit rod in the parking state; and
wherein the auxiliary pedal is movably connected to the main pedal, wherein when the auxiliary pedal is depressed by the user, the hook plate is separated from the limit rod.

13. The outdoor garden working vehicle according to claim 12, wherein a holding force for the hook plate torsion spring to maintain contact between the hook plate and the limit rod ranges from 5 N to 30 N.

14. The outdoor garden working vehicle according to claim 12, further comprising:
a recognition module configured to detect whether the main pedal is depressed;
a control system comprising a vehicle control module, a motor control module, and a battery management module, wherein:
the vehicle control module, the motor control module, and the battery management module are in signal communication with one another;
the battery management module is in signal communication with the power supply unit; and
the motor control module is in signal communication with the left drive motor and the right drive motor,
wherein the control system is configured to control, in response to detecting depression of the main pedal by the recognition module, the left drive motor and the right drive motor to stop rotating.

15. The outdoor garden working vehicle according to claim 1, wherein a hydraulic brake force damping adjustment mechanism is provided at the foot brake pump, the hydraulic brake force damping adjustment mechanism being configured to enable the pedal assembly to be further depressed when hydraulic oil inside the foot brake pump is compressed to the limit.

16. The outdoor garden working vehicle according to claim 15, wherein the hydraulic brake force damping adjustment mechanism comprises:
an oil pump bracket fixed to the frame; and
a damping member connected to the foot brake pump and the oil pump bracket.

17. The outdoor garden working vehicle according to claim 16, wherein the hydraulic brake force damping adjustment mechanism further comprises a guide member connected to the foot brake pump, the guide member being configured to restrict the foot brake pump to reciprocate only in a direction along which the foot brake pump is depressed by the pedal assembly.

18. The outdoor garden working vehicle according to claim 17, wherein:
the damping member is a damping compression spring;
the guide member is a bolt, wherein:
the bolt sequentially passes through the foot brake pump and the damping compression spring, and is threadedly connected to the oil pump bracket; and
the damping member has an initial damping force after being assembled.

19. An outdoor garden working vehicle, comprising:
a frame;
a left drive axle assembly and a right drive axle assembly, wherein the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel;
a mowing mechanism disposed at a lower portion of the frame for cutting ground vegetation;
a power supply unit electrically connected to the left drive motor, the right drive motor, and the mowing mechanism, and configured to supply power to the left drive motor, the right drive motor, and the mowing mechanism; and
a braking module comprising a parking and service brake assembly, wherein the parking and service brake assembly is configured to be depressed by a user to generate a braking force on the left drive axle assembly and the right drive axle assembly,
wherein the parking and service brake assembly comprises a pedal assembly, the pedal assembly comprising a main pedal and an auxiliary pedal, wherein the main pedal is configured to be depressed by the user to bring the braking module into either a braking state or a parking state, and wherein the auxiliary pedal is configured to be depressed by the user to release the braking module from the parking state.

20. An electric outdoor garden working vehicle, comprising:
a frame;
a left drive axle assembly and a right drive axle assembly, wherein the left drive axle assembly is mechanically coupled between a left drive motor and a left drive wheel and configured to transmit power from the left drive motor to the left drive wheel, and the right drive axle assembly is mechanically coupled between a right drive motor and a right drive wheel and configured to transmit power from the right drive motor to the right drive wheel;
a working mechanism disposed at a lower portion of the frame for performing outdoor work on the ground;
a power supply unit electrically connected to the left drive motor, the right drive motor, and the working mechanism, the power supply unit being configured to supply power to the left drive motor, the right drive motor, and the working mechanism; and
a braking module comprising a parking and service brake assembly and a foot brake pump,
wherein the parking and service brake assembly comprises a pedal assembly, wherein the pedal assembly is configured to press, when being depressed by the user, the foot brake pump to generate a braking force on the left drive axle assembly and the right drive axle assembly.
